(19) United States
(12) Patent Application Publication
(10) Pub. No.: US 2017/0151036 A1
(43) Pub. Date: Jun. 1, 2017

(54) VIBRATORY INSTRUMENT WITH IMPROVED TOOL-CHANGING MEANS

(71) Applicant: Patrick LESAGE, Saint-Malo (FR)

(72) Inventor: Patrick LESAGE, Saint-Malo (FR)

(21) Appl. No.: 15/327,394

(22) PCT Filed: Jul. 21, 2015
(86) PCT No.: PCT/FR2015/052008

§ 371 Date: Jan. 19, 2017

(30) Foreign Application Priority Data
Jul. 23, 2014 (FR) 1457091

(51) Int. Cl. A61C 1/14; A61C 3/03; A61C 1/07

(52) U.S. Cl. CPC A61C 1/148; A61C 1/07; A61C 3/03

(57) ABSTRACT

An instrument that includes a tod; a tool-holder; complementary means for vibrational coupling of the tool to the tool-holder which can be activated by relative movement of the tool and the tool-holder along a vibrational coupling/uncoupling stroke; and complementary rclcaaable means for attaching the tool to the tool-holder allowing, when the tool is attached to the tool-holder, the vibrational coupling/uncoupling stroke. The attachment means may include two attachment members, male and female, which can be attached together by relative movement along an attachment/detachment stroke. The attachment members cannot be deformed during the attachment/detachment stroke. The stroke includes an axial component and a component in a plane substantially transverse to the axial component, referred to as the transverse component. The axial and transverse components of the attachment/detachment stroke are defined by complementary interlocking shapes provided on the two connection members

The present invention relates to the field of vibratory instruments, particularly for a dental handpiece.

Dentists, in fact, frequently use a device, usually known as a dental handpiece, that is provided with a vibratory instrument that allows, in particular scaling, planing or cutting a tooth.

The vibrations transmitted to the vibratory instrument are generally ultrasonic or sonic.

A vibratory instrument is already known from the prior art, in particular from FR 2 957 243, that comprises a tool, a tool-holder and complementary releasable means for vibrational coupling of the tool to the tool-holder in order to transmit vibrations from the tool-holder to the tool.

The vibrational coupling means usually comprise complementary vibrational coupling surfaces, which are generally conical or cylindro-conical, provided, respectively, on the tool and the tool-holder. These coupling means can be activated by relative movement of the tool and of the tool-holder along a coupling stroke that places the complementary vibrational coupling surfaces in contact. Thus, when the user, holding the handpiece, bears on a tooth using the tool, he gives rise to a relative movement between the tool and the tool-holder, leading to contact being established between the complementary vibrational coupling surfaces and, as a result, transmission of vibrations from the tool-holder to the tool. When the user moves the tool away from the tooth, the complementary vibrational coupling surfaces tend to separate from one another so that the tool no longer vibrates.

It is thus necessary to allow a coupling/uncoupling stroke of the complementary vibrational coupling surfaces while still keeping the tool and tool-holder connected together. To that end, the vibratory instrument described in FR 2 957 243 includes complementary releasable means for attaching the tool to the tool-holder, allowing, when a tool is attached to the tool-holder, the vibrational coupling/uncoupling stroke.

These attachment means include two attachment members, respectively a male and a female attachment member that can be attached together by relative movement along an attachment/detachment stroke that includes an axial component. The attachment members described in FR 2 957 243 are of the snap-fit type. Snap-fitting is achieved by relative axial movement of the two attachment members, by thus traveling through an axial attachment stroke.

The female attachment member is carried by the tool-holder and the male attachment member, which is elastically deformable, is carried by the tool. More particularly, the male attachment member has a general axisymmetrical shape and is split axially in such a manner as to locally allow the radial deformation thereof when the attachment/detachment stroke is executed. The male attachment member is provided with a collar, its elastic radial deformation of the attachment member making it possible either to interlock the collar into a complementary cutout provided in the female attachment member or to separate this collar from the cutout.

The attachment means described in FR 2 957 243 are relatively reliable. However, in a vibratory instrument such as that used by a dentist, the tool-holder and the tool are relatively slender, with the result that the split male attachment member is ultimately, in certain use circumstances, relatively fragile.

An object of the invention is to propose means for attachment of the tool to the tool-holder that are more robust than those proposed by FR 2 957 243, while retaining simple attachment means.

To that end, a subject of the invention is a vibratory instrument comprising:
a tool,
a tool-holder,
complementary releasable means for vibrational coupling of the tool to the tool-holder in order to transmit vibrations from the tool-holder to the tool, it being possible to activate these complementary coupling means by relative movement of the tool and the tool-holder along a vibrational coupling/uncoupling stroke, and
complementary releasable means for attaching the tool to the tool-holder, allowing, when the tool is attached to the tool-holder, the vibrational coupling/uncoupling stroke, these attachment means including two, respectively male and female, attachment members that can be attached together by relative movement along an attachment/detachment stroke that includes an axial component,

characterized in that the male and female attachment members cannot be deformed during the attachment/detachment stroke, this stroke also including a component in a plane substantially transverse to the axial component, referred to as the transverse component, the axial and transverse components of the attachment/detachment stroke being defined by complementary interlocking shapes provided on the two attachment members.

The male and female attachment members proposed by the invention cannot be deformed during the attachment/detachment stroke and are therefore relatively more robust than those proposed in the prior art.

Furthermore, the stroke that allows the attachment or detachment of the male and female members is easily defined by the complementary interlocking shapes provided on the two attachment members.

Furthermore, the invention dispenses with the addition of supplementary elements to the usual attachment means. Indeed, the invention makes it possible to require, simply, by virtue of appropriate shapes provided on the existing attachment members, an attachment/detachment stroke that is sufficiently complex that it is not traveled through unexpectedly, without a deliberate action on the part of the user. This prevents any untimely separation of the complementary attachment means.

According to different optional features that correspond to different variants or to different embodiments of the invention:
the two male and female attachment members are carried, respectively, by the tool and the tool-holder;
the male attachment member is carried by the tool, the female attachment member being movable relative to the tool and to the tool-holder along the transverse component of the attachment/detachment stroke;
the female attachment member including a recess delimited by a first axial retention stop designed to interact, with clearance, with a second axial retention stop provided on the male attachment member in order to define one end of the vibrational coupling/decoupling stroke corresponding to a position of deactivation of the vibrational coupling means;
the complementary interlocking shapes of the two attachment members are complementary threads, the attachment/detachment stroke being a movement of screwing the two attachment members, simultaneously combining the axial and transverse components of the attachment/detachment stroke;
the complementary interlocking shapes of the two attachment members are of the bayonet type, which requires the axial and transverse components of the attachment/detachment stroke to be performed separately;
the complementary interlocking shapes of the two attachment members comprise at least one tongue designed to interact with a complementary groove in order to define the axial component of the attachment/detachment stroke, the recess forming a cutout allowing the transverse component of the attachment/detachment stroke;
the complementary vibrational coupling means comprise complementary vibrational coupling surfaces, preferably conical or cylindro-conical complementary surfaces, provided, respectively, on the tool and the tool-holder;
the tool-holder has a general elongate shape in a longilinear direction, which is optionally elbowed or curved, the axial component of the attachment/detachment course being substantially parallel to the longilinear direction of the tool-holder;
the complementary interlocking shapes of the attachment members are, when the tool is attached to the tool-holder, separated from one another and intercalated axially between the complementary vibrational coupling surfaces and the two complementary centering surfaces provided, respectively, on the male and female attachment members in order to limit the radial deviations of these two attachment members relative to one another;
the tool-holder has a general elongate shape in a longilinear direction, which is optionally elbowed or curved, the axial component of the attachment/detachment stroke being substantially transverse to the longilinear direction of the tool-holder;
the tool-holder has a general elongate shape, which is elbowed or curved, the tool being provided with a working end extending parallel to a plane substantially parallel to this elbowed or curved shape and toward the exterior of this elbowed or curved shape;
when the tool is attached to the tool-holder, the tool traverses an envelope covering the tool-holder, the female attachment member being mounted on this envelope in such a manner as to be movable relative to the tool and to the tool-holder along the transverse component of the attachment/detachment stroke;
the complementary interlocking shapes of the attachment members are, when the tool is attached to the tool-holder, interlocked with one another, two complementary centering surfaces, provided, respectively, on the male attachment member and on the tool-holder, being intercalated axially between the complementary vibrational coupling surfaces and the female attachment member, these centering surfaces being designed to limit the radial deviations of the two attachment members relative to one another.

A further subject of the invention is a handpiece provided with a vibratory instrument, characterized in that the vibratory instrument is as defined above.

The invention will be better understood upon the following reading given solely by way of non-limiting example and with reference to the appended drawings, in which:

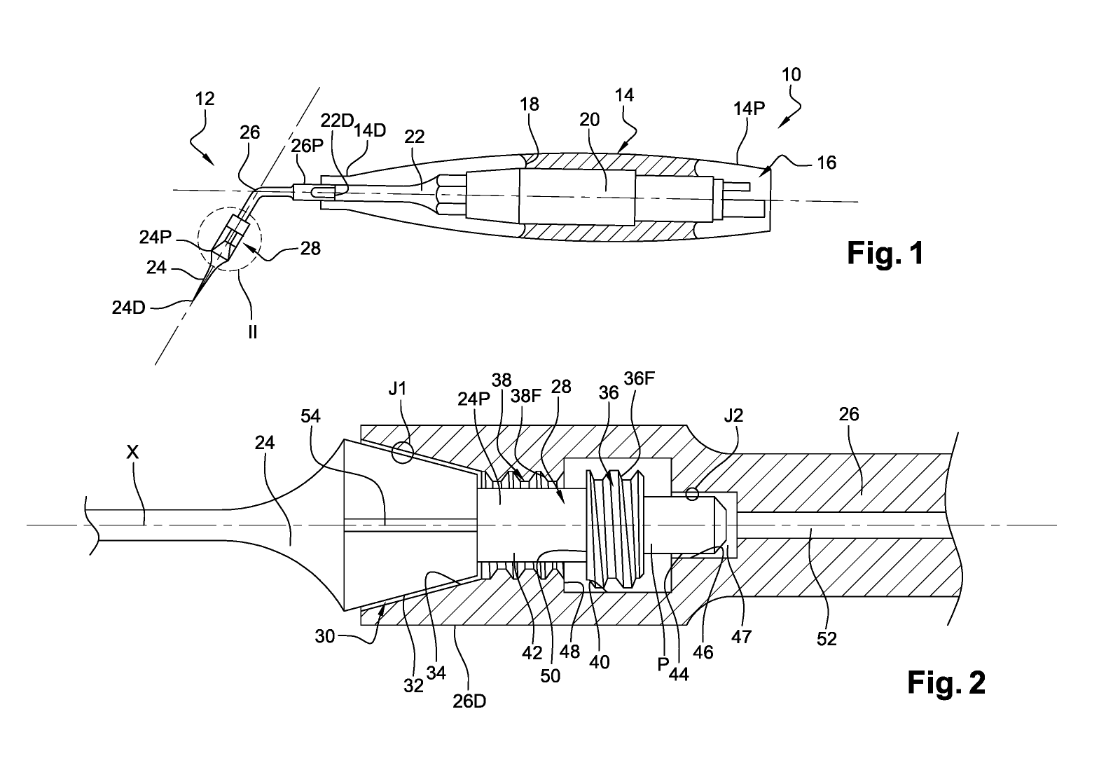

FIG. 1 is a schematic view with localized axial sections of a handpiece according to the invention, this handpiece including a vibratory instrument according to a first embodiment of the invention;

FIG. 2 is an axial sectional view of the part II circled in FIG. 1, showing the attachment means of the vibratory instrument carried by the handpiece shown in FIG. 1;

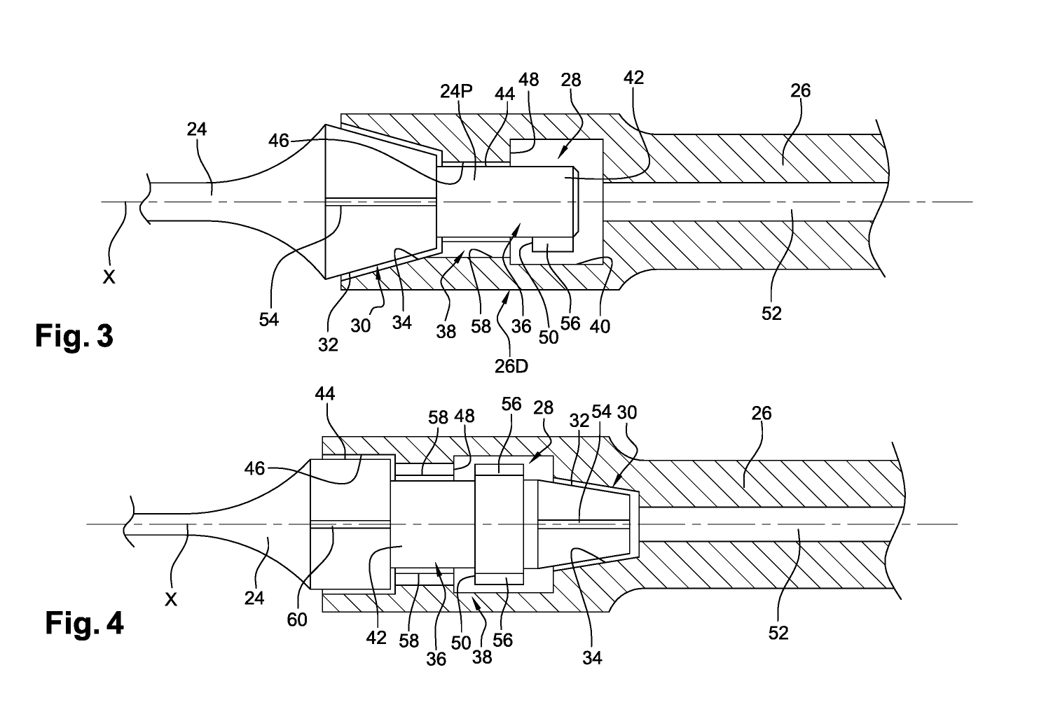

FIGS. 3 and 4 are views similar to FIG. 2, respectively showing first and second variant embodiments of attachment means of the vibratory instrument carried by the handpiece shown in FIG. 1;

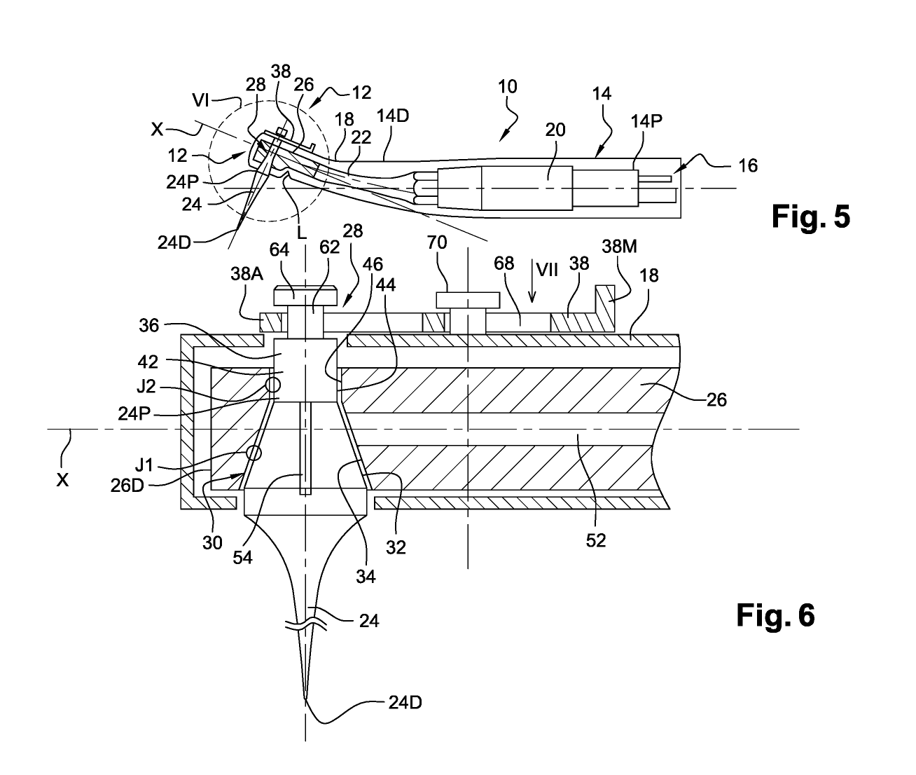

FIG. 5 is a view similar to that of FIG. 1, the handpiece including, in this case, a vibratory instrument according to a second embodiment of the invention;

FIG. 6 is an axial sectional view of the part VI circled in FIG. 5, showing the attachment means of the vibratory instrument carried by the handpiece shown in FIG. 5;

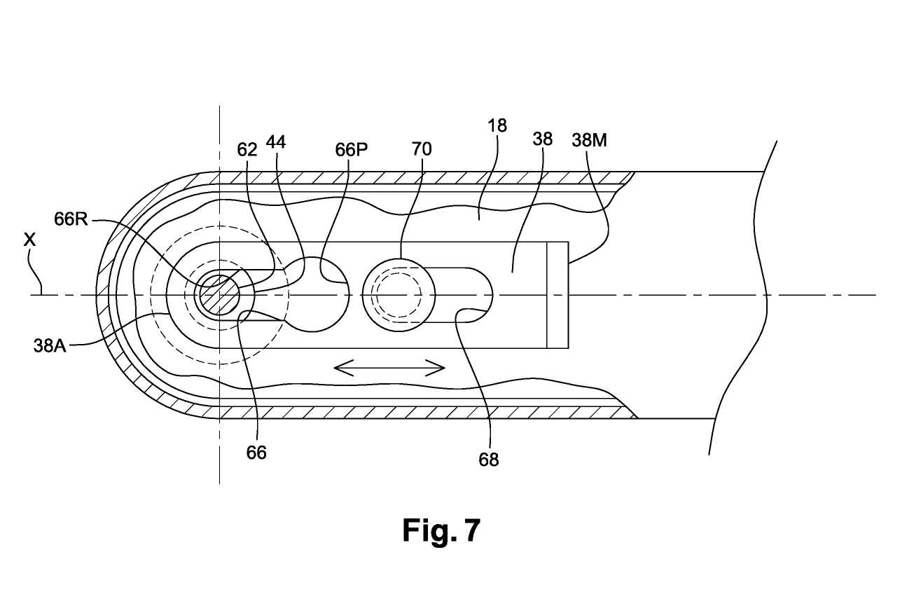

FIG. 7 is a view in the direction of the arrow VII in FIG. 6, with localized axial sections.

FIG. 1 shows a device, usually called a handpiece, denoted by general reference 10. This device is designed for use by a dentist.

The handpiece 10 is provided with a vibratory instrument 12 according to a first embodiment of the invention. This vibratory instrument 12 can allow, in particular, scaling, planing or tooth cutting.

Conventionally, the handpiece 10 comprises a body 14 with a general shape adapted to this body 14 being gripped by a user's hand.

In the following text, in accordance with a conventional use, a proximal or distal element will be described depending on whether this element is close (proximal) or distant (distal) from the user's hand.

The body 14 comprises a proximal end 14P provided with conventional means 16 for connection to a cord (not shown) for supplying fluids (water, air) and current to the handpiece 10.

The body 14 also comprises a distal end 14D extended by the vibratory instrument 12.

The body 14 further comprises an envelope 18 accommodating the conventional means including means 20 for generating sonic or ultrasonic vibrations and a member 22 for conveying vibrations between the vibration-generating means and the vibratory instrument 12.

The vibratory instrument 12 comprises a tool 24 and a tool-holder 26.

The tool 24 is provided with a distal working end 24D designed, in particular, to come into contact with a patient's tooth.

The tool-holder 26 is provided with a proximal end 26P connected, in a manner known per se, to a distal end 22D of the vibration-conveying member 22, for example by screwing (as shown), welding, adhesive bonding, etc. In a variant, the tool-holder 26 may extend the vibration-conveying member 22 by being made as a single piece with the latter.

In the example illustrated in FIG. 1, it will be noted that the tool-holder 26 has a general elongate shape in an elbowed longilinear direction.

The proximal end 24P of the tool 24 is attached to the distal end 26D of the tool-holder 26 with the aid of complementary releasable means 28 for attaching the tool 24 to the tool-holder 26. These attachment means 28, shown in greater detail in FIG. 2, allow the rotation of the tool 24 about the longilinear direction of the tool-holder 26.

The vibratory instrument 12 is likewise provided with complementary releasable means 30 for vibrational coupling of the tool 24 to the tool-holder 26, shown in greater detail in FIG. 2.

With reference to FIG. 2, it will be seen that the complementary vibrational coupling means 30 comprise two complementary surfaces 32, 34, which are preferably conical, as illustrated in this FIG. 2. These conical surfaces 32, 34 diverge in the proximal-to-distal direction. A first vibrational coupling surface 32 is a conical male surface provided on the proximal end 24P of the tool 24. The second vibrational coupling surface 34 is a conical female surface provided on the distal end 26D of the tool-holder 26.

In a variant, the complementary vibrational coupling surfaces could have other shapes, for example cylindro-conical shapes.

It will be noted that, when the proximal end 24P of the tool 24 is attached to the distal end 26D of the tool-holder 26, as shown in FIG. 2, there is a clearance J1 between the two complementary vibrational coupling surfaces 32, 34.

By virtue of this clearance J1, the complementary vibrational coupling means 30 can be activated by relative movement of the tool 24 and of the tool-holder 26 along a vibrational coupling/decoupling stroke allowed by this clearance. This coupling/decoupling stroke generally include at least one of the following two components:
an axial component substantially parallel to the longilinear direction X of the distal end 26D of the tool-holder 26; and
a radial component, substantially perpendicular to the axial component.

Thus, when the user, holding the handpiece 10, bears on a tooth with the tool 24, he gives rise to a relative movement between the tool 24 and the tool-holder 26 that leads to contact being established between the complementary vibrational coupling surfaces 32, 34 and, as a result, to the transmission of vibrations from the tool-holder 26 to the tool 24. When the user moves the tool 24 away from the tooth, the vibrational coupling surfaces 32, 34 tend to separate from one another in order that the tool 24 no longer vibrates.

The attachment means 28 allow, when the tool 24 is attached to the tool-holder 26, the vibrational coupling/decoupling stroke described above, while keeping the tool 24 and the tool-holder 26 connected together. To that end, the attachment means 28 include two attachment members, respectively a male 36 and a female 38 member, that can be attached together or separated from one another by relative movement along an attachment/detachment stroke.

In the case of the vibratory instrument 12 illustrated in FIG. 1, the two male 36 and female 38 attachment members are carried, respectively, by the tool 24 and the tool-holder 26.

If the two attachment members 36, 38 are considered in the configuration where they are attached to one another (see FIG. 2), it will be seen that each attachment member 36, 38 has a general axisymmetrical shape about the longilinear direction X of the distal end 26D of the tool-holder 26 in order to allow the free rotation of the tool 24 about this direction X relative to the tool-holder 26.

The attachment/detachment stroke is defined by complementary interlocking shapes on the two attachment members 36, 38. It will be noted that these two attachment members 36, 38 do not deform during the attachment/detachment stroke.

In the case of the vibratory instrument 12 illustrated in FIGS. 1 and 2, the complementary interlocking shapes of the two attachment members 36, 38 are complementary threads 36F, 38F provided on these members.

These complementary threads 36F, 38F make it possible to define an attachment/detachment stroke that includes a first, axial component and a second component, called a transverse component, in a plane substantially transverse to the first axial component.

Thus, in the case of the two attachment members 36, 38 illustrated in FIG. 2, the attachment/detachment stroke is a movement of screwing the two attachment members 36, 38, simultaneously combining the axial and transverse components of the attachment/detachment stroke. In fact, the axial component in this case is a translation substantially parallel to the longilinear direction X of the distal end 26D of the tool-holder 26, and the transverse component is a rotation in a plane substantially transverse to this longilinear direction X.

With reference to FIG. 2, it will be noted that the female attachment member 38 also includes a recess 40. The diameter of this recess 40 is largely greater than that of the thread 36F of the male attachment member 36. The thread 38F, also known as an internal screw thread 38F, provided in the female attachment member 38 is axially intercalated between the vibrational coupling surface 34 of this female attachment member 38 and the recess 40.

The male attachment member 36 includes an axisymmetrical shaft 42 with a diameter largely smaller than that of the internal screw thread 38F of the female attachment member 38. The thread 36F of the male attachment member 36 is connected to the vibrational coupling surface 32 of the tool 24 by means of the shaft 42.

FIG. 2 shows the complementary interlocking shapes 36F, 38F, namely the threads 36F, 38F, in a configuration in which, the tool 24 being attached to the tool-holder 26, these shapes 36F, 38F are separated from one another. It will be seen in this case that the threads 36F, 38F of the attachment members 36, 38 are intercalated axially between the complementary vibrational coupling surfaces 32, 34 and two complementary centering surfaces 44, 46 provided on the male 36 and female 38 attachment members. These two centering surfaces 44, 46 are axisymmetrical and designed to interact with a radial clearance J2 in order to limit the radial deviations of the attachment members 36, 38 relative to one another when the tool 24 is attached to the tool-holder 26.

In the example shown in FIG. 2, the two centering surfaces 44, 46 are provided, respectively, on:
a centering stud P, which extends the male attachment member 36 away from the shaft 42; and
a centering bore 47 provided in the female attachment member 38 of the tool-holder 26, this bore 47 extending the recess 40 away from the internal screw thread 37F.

In a variant, the two centering surfaces 44, 46 could be dispensed with.

It will be noted that the smaller diameter of the female vibrational coupling surface 34 of the tool-holder 26 is greater than the diameter of the thread 36F of the male attachment member 36. It will likewise be noted that the diameter of the centering surface 44 of the tool 24 is smaller than the diameter of the thread 36F of the male attachment member 36.

In order to attach the tool 24 to the tool-holder 26, first of all the male attachment member 36 is inserted into the female attachment member 38 by axially passing the centering surface 44 of the tool 24 and the thread 36F of the male attachment member 36 across the vibrational coupling surface 34 of the tool-holder 26.

Next, the thread 36F of the male attachment member 36 is screwed into the internal screw thread 38F of the female attachment member 38 until the entire thread 36F of the male attachment member 36 emerges into the recess 40 of the tool-holder 26. This culminates in the relative position of the attachment members 36, 38 shown in FIG. 2.

It will be noted that the recess 40 is delimited by a surface forming a first axial retention stop 48 designed to interact, with axial clearance, with a second axial retention stop 50 provided on the male attachment member 36, for example at a distal end of the thread 36F. Interaction of the axial retention stops 48, 50 defines an end of the vibrational coupling/decoupling stroke corresponding to a position of deactivation of the vibrational coupling means 30.

When the tool 24 is attached to the tool-holder 26, the interaction, with clearance, of the centering surfaces 44, 46 enables the radial deviations of the attachment members 36, 38 relative to one another to be limited. This thus avoids any undesirable radial contact, on the one hand of the internal screw thread 38F against the shaft 42 and, on the other, of the thread 36F against the surface delimiting the recess 40, which may lead to peening of the threads 36F, 38F.

The dimensions of the recess 40 are adapted to allow axial and radial deviations of the thread 36F in this recess 40 as a result of the vibrational coupling/uncoupling stroke between the tool 24 and the tool-holder 26.

Furthermore, in the case illustrated in FIG. 2, the complementary interlocking shapes of the two attachment members 36, 38 are threads 36F, 38F requiring an attachment/detachment stroke by screwing. This screwing is a stroke that is sufficiently complex to not be traveled through unexpectedly, without deliberate action on the part of the user of the handpiece 10.

Provision is made in the handpiece for conventional means for the circulation of at least one fluid (water and/or air) designed, for example, for cooling the tool and/or for generating a stream of fluid toward a zone treated by the user. These fluid-circulation means comprise, in the example shown in FIG. 2, a channel 52 provided in the tool-holder 26 and grooves 54 provided in at least one of the complementary vibrational coupling surfaces, for example the surface 32 of the tool 24, as shown in FIG. 2.

When the tool 24 is attached to the tool-holder 26, the complementary interlocking shapes 36F, 38F of the two attachment members 36, 38 are separated from one another and thus allow the passage of fluid from the channel 52 toward the grooves 54, passing via the bore 47, the recess 40 and the internal screw thread 38F.

With reference to FIGS. 3 to 7 a description will be given below of variant embodiments of attachment means and also a second embodiment of the vibratory instrument. In these FIGS. 3 to 7, the elements that are similar to those of FIGS. 1 and 2 are denoted by identical references.

FIG. 3 shows a first variant embodiment of the attachment means 28.

In this case, the complementary interlocking shapes of the two attachment members 36, 38 are of the bayonet type and comprise an axial interlocking tongue 56 carried, for example, by the shaft 42 of the male attachment member 36, which is designed to interact with a complementary axial interlocking groove 58 provided, for example, in the female attachment member 38.

If the two attachment members 36, 38 are considered in the configuration in which they are attached to one another, as shown in FIG. 3, the two complementary centering surfaces 44, 46 are intercalated axially between the complementary vibrational coupling surfaces 32, 34 and the recess 40. In the case of FIG. 3, the centering surface 44 delimits the shaft 42 and the axial interlocking groove 58 is provided in the centering surface 46.

The complementary interlocking shapes illustrated in FIG. 3 require the axial and transverse components of the attachment/detachment stroke to be performed separately.

In fact, in accordance with a bayonet-type stroke, in order to attach the tool 24 to the tool-holder 26 it is first necessary to interlock the tongue 56 in the groove 58 via translational movement substantially parallel to the longilinear direction X of the distal end 26D of the tool-holder 26 until this tongue 56 is inserted into the recess 40. Next, the male attachment member 36 is turned about the longilinear direction X in order angularly to offset the tongue 56 relative to the groove 58.

By means of interlocking interaction with the groove 58, the tongue 56 defines the axial component of the attachment/detachment stroke. Furthermore, the recess 40 forms a cutout allowing the transverse component of the attachment stroke. In fact, this transverse component is a rotation in a plane substantially transverse to the longilinear direction X.

The tool 24 is detached from the tool-holder 26, mutatis mutandis, by executing the stroke in a form that is the reverse of that described above.

The bayonet-type stroke is a stroke that is sufficiently complex to not be traveled through unexpectedly, without deliberate action on the part of the user of the handpiece 10.

It will be noted that the dimensions of the recess 40 are adapted to allow the axial and radial deviations of the tongue 56 in this recess 40 as a result of the vibrational coupling/uncoupling stroke between the tool 24 and the tool-holder 26. This prevents any undesirable radial contact of the tongue 56 against the surface delimiting the recess 40.

It will also be noted that, in the case of FIG. 3, the second axial retention stop 50 carried by the male attachment member 36 is formed by a distal end of the tongue 56. However, as in the case of FIG. 2, the first axial retention stop 48 delimits the recess 40.

FIG. 4 shows a second variant embodiment of the attachment means 28.

In this case, as for the first variant shown in FIG. 3, the complementary interlocking shapes of the two attachment members 36, 38 are of the bayonet type. However, in this case, the complementary interlocking shapes comprise a plurality of axial interlocking tongues 56 designed to interact with the same number of complementary axial interlocking grooves 58. The number of interlocking tongues 56 is, for example, between 2 and 4.

Furthermore, in connection with the case shown in FIG. 2, it will be noted that if the two attachment members 36, 38 are considered in the configuration in which they are attached to one another, as shown in FIG. 4, the axial position of the complementary vibrational coupling surfaces 32, 34 is reversed relative to the axial position of the complementary centering surfaces 44, 46.

Lastly, in the variant shown in FIG. 4, grooves 60 for the circulation of fluid are provided in at least one of the complementary centering surfaces, for example the surface 44 of the male attachment member 36, as shown in FIG. 2.

FIGS. 5 to 7 show a handpiece 10 that includes a vibratory instrument 12 according to a second embodiment of the invention.

In this case, the tool-holder 26 extends the vibration-conveying member 22. In a variant, the tool-holder 26 may be connected to the vibration-conveying member 22 by means of screwing, welding, adhesive bonding, etc.

Furthermore, the tool-holder 26 has a general elongate shape in a curved longilinear direction X.

Unlike the vibratory instrument 12 shown in FIG. 1, the axial component of the attachment/detachment stroke of the tool 24 vis-à-vis the tool-holder 26 is, in this case, substantially transverse to the longilinear direction X of this tool-holder 26.

Furthermore, as may be seen in FIG. 5, the distal working end 24D of the tool 24 extends, first, parallel to a plane substantially parallel to the curved general elongate shape of the tool-holder 26 and, second, toward the exterior of this curved shape.

This arrangement of the distal working end 24D of the tool 24 allows efficient illumination of a zone treated by the user in the form of a conventional light source placed, for example, at the point L of the tool-holder 26 indicated in FIG. 5.

The vibratory instrument according to the second embodiment of the invention is usually denoted as being of the “contra angle” type. This “contra angle” could also be obtained with a tool-holder 26 having a general elongate shape in an elbowed longilinear direction X.

In this second embodiment of the vibratory instrument, the envelope 18 covers the tool-holder 26. When the tool 24 is attached to the tool-holder 26, the tool 24 traverses the envelope 18 in such a manner that the male attachment member 36 extends substantially transversely to the longilinear direction X of the distal end of the tool-holder 24.

The shaft 42 of the male attachment member 36 includes an end for connection to the vibrational coupling surface 32 and a free end projecting to the exterior of the envelope 18 when the tool 24 is attached to the tool-holder 26.

The shaft 42 is provided with an annular trough 62 separating the ends of the shaft 42 in order to confer a retention-head function on the free end of the shaft 42. The free end of the shaft 42 will thus henceforth be called the “retention head 64”.

As may be seen in FIG. 6, in the second embodiment of the vibratory instrument 12, the centering surface 44 delimits the shaft 42 and the complementary centering surface 46 of the surface 44 is provided on the proximal end 26D of the tool-holder 26.

Furthermore, unlike the first embodiment, in the second embodiment of the vibratory instrument 12, the female attachment member is formed by a slide 38 mounted so as to be movable in translation on the envelope 18. In a variant, the slide 38 could be mounted so as to be movable in translation on the tool-holder 26.

With reference to FIGS. 6 and 7, it will be seen that the slide 38 comprises a maneuvering end 38M and an attachment end 38A. The attachment end 38A comprises a slot 66 provided with a through-end 66P, allowing the passage through this end 66P of the retention head 64, and a retention end 66R designed to interlock in the trough 62.

The trough 62 and the slot 66 thus form the complementary interlocking shapes of the two attachment members 36, 38.

In order to guide the slide 38 and to limit the stroke thereof, this slide 38 includes an oblong hole 68 designed to interact with a travel-guide and -limiting stud 70 integral with the envelope 18.

As in the first embodiment of the vibratory instrument, a channel 52 is provided in the tool-holder 26 and grooves 54 are provided in at least one of the complementary vibrational coupling surfaces, for example the surface 32 of the tool 24, as shown in FIG. 6.

In order to attach the tool 24 to the tool-holder 26, first of all the slide 38 is placed in such a manner as to align the through-end 66P of the slot 66 with the vibrational coupling surfaces 34 and centering surfaces 46 provided in the tool-holder 26.

Next, by means of a first translational movement substantially coaxial to this alignment, the retention head 64 of the male attachment member 36 is inserted into the through-end 66P of the slot 66 of the slide 38 forming the female attachment member. This first translational movement corresponds to the axial component of the attachment/detachment stroke.

Then, the slide 38 is moved in a second translational movement, perpendicularly to the axial component of the attachment/detachment stroke in order to interlock the groove 62 of the male attachment member 36 in the retention end 66R of the slot 66 of this slide 38. This second translational movement corresponds to the transverse component of the attachment/detachment stroke. Thus, the slide 38 forming the female attachment member is mounted on the envelope 18 in such a manner as to be movable relative to the tool 24 and to the tool-holder 26, in accordance with the transverse component of the attachment/detachment stroke.

It will thus be noted that, unlike the first embodiment, the complementary interlocking shapes of the attachment members 36, 38, i.e. the trough 62 and the retention end 66R of the slot 66, are, when the tool 24 is attached to the tool-holder 26, interlocked together.

If the two attachment members 36, 38 are considered in the configuration in which they are attached to one another (see FIG. 6), it will be seen that the male attachment member 36 has a general axisymmetrical shape, the retention end 66R of the slot 66 allowing the free rotation of the tool 24 about its axis of revolution relative to the tool-holder 26.

Moreover, when the tool 24 is attached to the tool-holder 26, the complementary centering surfaces 44, 46 are intercalated axially between the complementary vibrational coupling surfaces 32, 34 and the slide 38 forming the female attachment member. It will be noted that these complementary centering surfaces 44, 46 are optional.

The tool 24 is detached from the tool-holder 26, mutatis mutandis, by executing the stroke as the reverse of that which has just been described.

It will be noted that, as in the case of the first embodiment of the invention, the two attachment members 36, 38 do not deform during the attachment/detachment stroke.

Naturally, the axial and radial dimensions of the trough 62 and the retention end 66R of the slot 66 are adapted in order to allow the axial and radial deviations of the retention head 64 in the trough 62 resulting from the vibrational coupling/uncoupling stroke between the tool 24 and the tool-holder 26.

It will be noted that the stroke-guide and -limiting stud 70 allows correct positioning of the retention end 66R of the slot 66 relative to the trough 62 in order to prevent any undesirable contact between the male attachment member 36 and the slide 38 forming the female attachment member.

For the purposes of the satisfactory execution of the vibrational coupling/uncoupling and attachment/detachment stroke when the members 36, 38 are attached together, the kinematics of the various movable elements of the vibratory instrument according to the above-described embodiments require appropriate mechanical clearances, not all of which have been mentioned but which the person skilled in the art will be able to define in terms of position and dimension, particularly in light of that which has been described above.

1. A vibratory instrument comprising:
a tool,
a tool-holder,
a vibrational coupling portion for vibrational coupling of the tool to the tool-holder in order to transmit vibrations from the tool-holder to the tool, it being possible to activate the vibrational coupling portion by relative movement of the tool and the tool-holder along a vibrational coupling/uncoupling stroke, and
complementary attachment portion for attaching the tool to the tool-holder, allowing, when the tool is attached to the tool-holder, the vibrational coupling/uncoupling stroke, the attachment portion including two, respectively male and female, attachment members that can be attached together by relative movement along an attachment/detachment stroke that includes an axial component,
wherein the male and female attachment members cannot be deformed during the attachment/detachment stroke, this stroke also including a component in a plane substantially transverse to the axial component, referred to as the transverse component, the axial and transverse components of the attachment/detachment stroke being defined by complementary interlocking shapes provided on the two attachment members.

2. The vibratory instrument as claimed in claim 1, wherein the two male and female attachment members are carried, respectively, by the tool and the tool-holder.

3. The vibratory instrument as claimed in claim 1, wherein the male attachment member is carried by the tool, the female attachment member being movable relative to the tool and to the tool-holder along the transverse component of the attachment/detachment stroke.

4. The vibratory instrument as claimed in claim 1, the female attachment member including a recess delimited by a first axial retention stop designed to interact, with clearance, with a second axial retention stop provided on the male attachment member in order to define one end of the vibrational coupling/decoupling travel corresponding to a position of deactivation of the vibrational coupling portion.

5. The vibratory instrument as claimed in claim 1, wherein the complementary interlocking shapes of the two attachment members are complementary threads, the attachment/detachment stroke being a movement of screwing the two attachment members, simultaneously combining axial and transverse components of the attachment/detachment stroke.

6. The vibratory instrument as claimed in claim 5, wherein the complementary interlocking shapes of the two attachment members are of a bayonet type, which requires the axial and transverse components of the attachment/detachment stroke to be performed separately.

7. The vibratory instrument as claimed in claim 6, wherein the complementary interlocking shapes of the two attachment members comprise at least one tongue designed to interact with a complementary groove in order to define the axial component of the attachment/detachment stroke, a recess forming a cutout allowing the transverse component of the attachment/detachment stroke.

8. The vibratory instrument as claimed in claim 1, wherein the vibrational coupling portion includes complementary vibrational coupling surfaces, including conical or cylindro-conical complementary surfaces, provided, respectively, on the tool and the tool-holder.

9. The vibratory instrument as claimed in claim 1, wherein the tool-holder has a general elongate shape in a longilinear direction, which is one of elbowed or curved, the axial component of the attachment/detachment stroke being substantially parallel to the longilinear direction of the tool-holder.

10. The vibratory instrument as claimed in claim 8, wherein the complementary interlocking shapes of the attachment members are, when the tool is attached to the tool-holder, separated from one another and intercalated axially between the complementary vibrational coupling surfaces and two complementary centering surfaces provided, respectively, on the male and female attachment members in order to limit the radial deviations of these two attachment members relative to one another.

11. The vibratory instrument as claimed claim 2, wherein the tool-holder has a general elongate shape in a longilinear direction, which is one of elbowed or curved, the axial component of the attachment/detachment stroke being substantially transverse to the longilinear direction of the tool-holder.

12. The vibratory instrument as claimed in claim 11, wherein the tool is provided with a working end extending parallel to a plane substantially parallel to the elbowed or curved shape and toward an exterior of the elbowed or curved shape.

13. The vibratory instrument as claimed in claim 11, wherein, when the tool is attached to the tool-holder, the tool traverses an envelope covering the tool-holder, the female attachment member being mounted on the envelope in such a manner as to be movable relative to the tool and to the tool-holder along the transverse component of the attachment/detachment stroke.

14. The vibratory instrument as claimed in claim 8, wherein the complementary interlocking shapes of the attachment members are, when the tool is attached to the tool-holder, interlocked with one another, two complementary centering surfaces, provided, respectively, on the male attachment member and on the tool-holder, being intercalated axially between the complementary vibrational coupling surfaces and the female attachment member, these centering surfaces being designed to limit the radial deviations of the two attachment members relative to one another.

15. A handpiece provided with a vibratory instrument, wherein the vibratory instrument is according to claim 1.
